(19) United States
(12) Patent Application Publication
(10) Pub. No.: US 2014/0319785 A1
(43) Pub. Date: Oct. 30, 2014

(54) Tool Holder with Tensioning Design

(71) Applicant: Chieh-Yuan CHEN, Taichung City (TW)

(72) Inventor: Chieh-Yuan CHEN, Taichung City (TW)

(21) Appl. No.: 13/872,664

(22) Filed: Apr. 29, 2013

(51) Int. Cl. B23B 31/20

(52) U.S. Cl. CPC B23B 31/201
USPC 279/43.5

(57) ABSTRACT

A tool holder with tensioning design includes a body and a tensioning device. The body is a hollow cylinder with a peripheral wall and a tool inserting hole, around the peripheral wall is formed an annular slot, the peripheral wall is further provided with a gap which extends along an axial direction of the body and in communication with the annular slot, the body is provided with two assembling portions at two sides of the gap. The tensioning device is disposed at the two assembling portions to tighten or loosen the two assembling portions. The annular slot and the gap allows for micro deformation of the two assembling portions. The use of the tool holder of the present invention is not restricted by the configuration of the tool to be held.

### BACKGROUND OF THE INVENTION

1. Field of the Invention

The present invention relates to a tool holder, and more particularly to a tool holder with tensioning design.

2. Description of the Prior Art

FIG. 1 shows a conventional tool holder 10 is a hollow cylindrical structure, which is used in combination with a steel ball 11 to position and fix a tool. However, the tool to be held by this tool holder 10 must be provided with an annular steel ball positioning cavity to engage with the steel ball 11, otherwise, the tool cannot be positioned. Therefore, the applicability of this tool holder 10 is limited.

The present invention has arisen to mitigate and/or obviate the afore-described disadvantages.

### SUMMARY OF THE INVENTION

The primary objective of the present invention is to provide a tool holder with tensioning design which is capable of overcoming the poor tool positioning ability of the conventional tool holder.

To achieve the above objective, a tool holder with tensioning design in accordance with the present invention comprises a body and a tensioning device.

The body is a hollow cylinder with a peripheral wall and a tool inserting hole, around the peripheral wall is formed an annular slot, the peripheral wall is further provided with a gap which extends along an axial direction of the body and in communication with the annular slot, the body is provided with two assembling portions at two sides of the gap.

The tensioning device is disposed at the two assembling portions to tighten or loosen the two assembling portions.

The annular slot and the gap allows for micro deformation of the two assembling portions, so that, when the two assembling portions slightly deform toward each other by pulling the handle, the tool inserted in the inserting hole can be clamped tightly. Furthermore, the use of the tool holder of the present invention is not restricted by the configuration of the tool to be held, namely, the tool holder is applicable to all the tools with or without steel ball positioning cavity.

### BRIEF DESCRIPTION OF THE DRAWINGS

FIG. 1 shows a conventional tool holder;

FIG. 2 is an exploded view of a tool holder with tensioning design in accordance with the present invention;

FIG. 3 is an assembly view of the tool holder with tensioning design in accordance with the present invention;

FIG. 4 illustrates a released state of the tool holder with tensioning design in accordance with the present invention;

FIG. 5 illustrates a tightened state of the tool holder with tensioning design in accordance with the present invention;

FIG. 6 illustrates a released state of the tool holder with tensioning design in accordance with another embodiment of the present invention; and

FIG. 7 illustrates a tightened state of the tool holder with tensioning design in accordance with another embodiment of the present invention.

### DETAILED DESCRIPTION OF THE PREFERRED EMBODIMENTS

The present invention will be clearer from the following description when viewed together with the accompanying drawings, which show, for purpose of illustrations only, the preferred embodiment in accordance with the present invention.

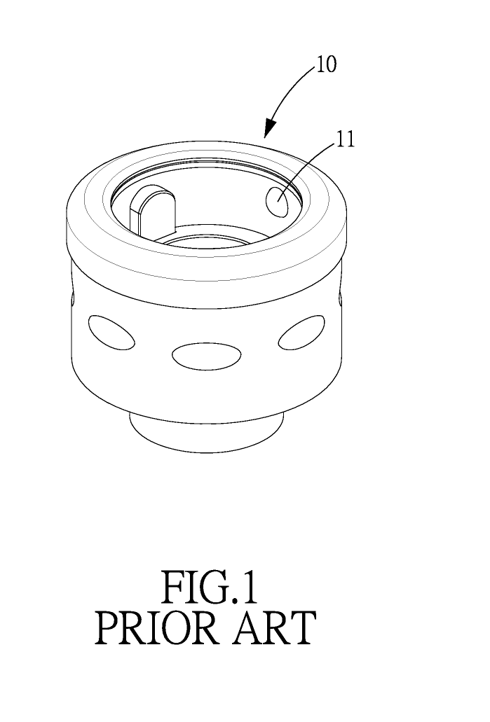

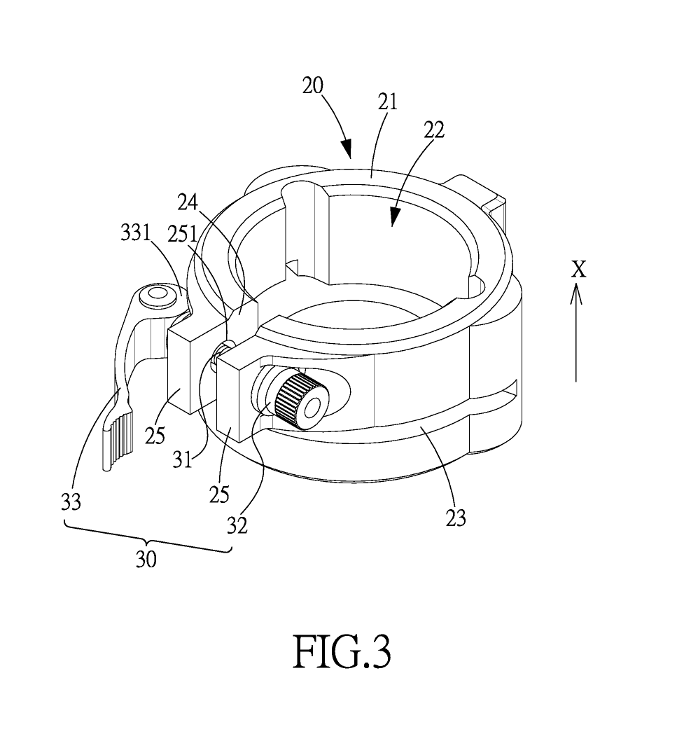

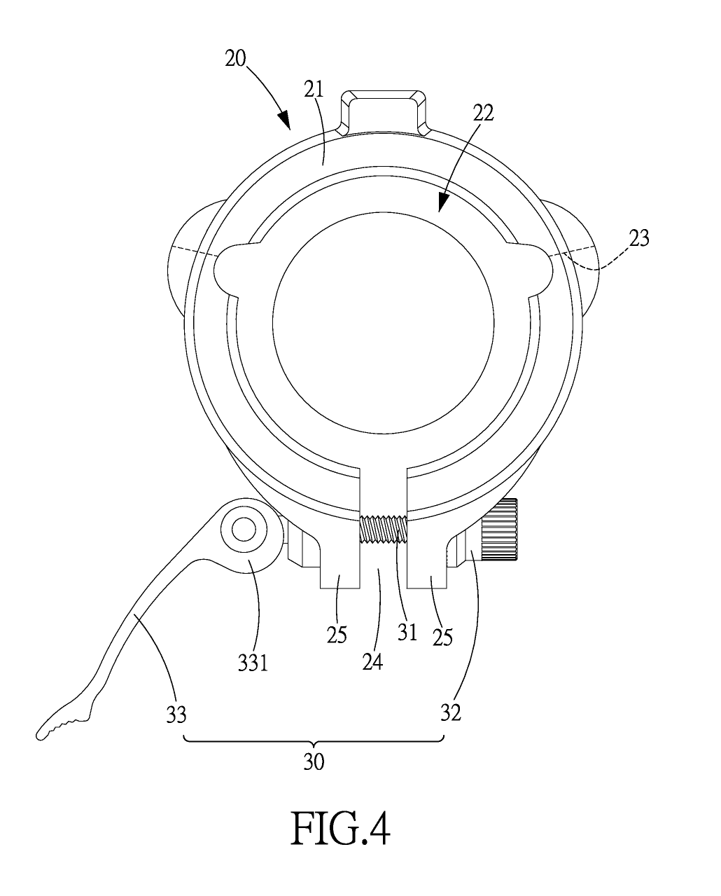

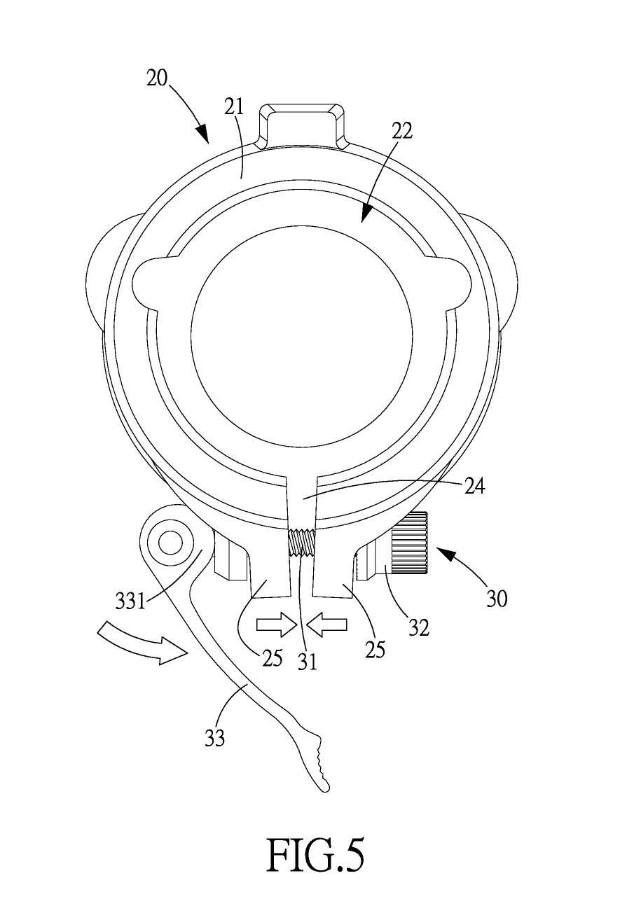

Referring to FIGS. 1-7, a tool holder with tensioning design in accordance with the present invention comprises: a body 20 and a tensioning device 30.

The body 20 is a hollow cylinder with a peripheral wall 21 and a tool inserting hole 22 for holding a tool. Around the peripheral wall 21 is formed an annular slot 23 which is longer than ½ circumference of the peripheral wall 21, and in this embodiment, the length of the annular slot 23 is ⅔ of the circumference of the peripheral wall 21. The peripheral wall 21 of the body 20 is further provided with a gap 24 which extends along an axial direction X of the body 20 and is in communication with the annular slot 23. The body 20 is provided with two assembling portions 25 at two sides of the gap 24. In this embodiment, the assembling portions 25 take the form of an ear and each are formed with a hole 251, and the two holes 251 are aligned with each other.

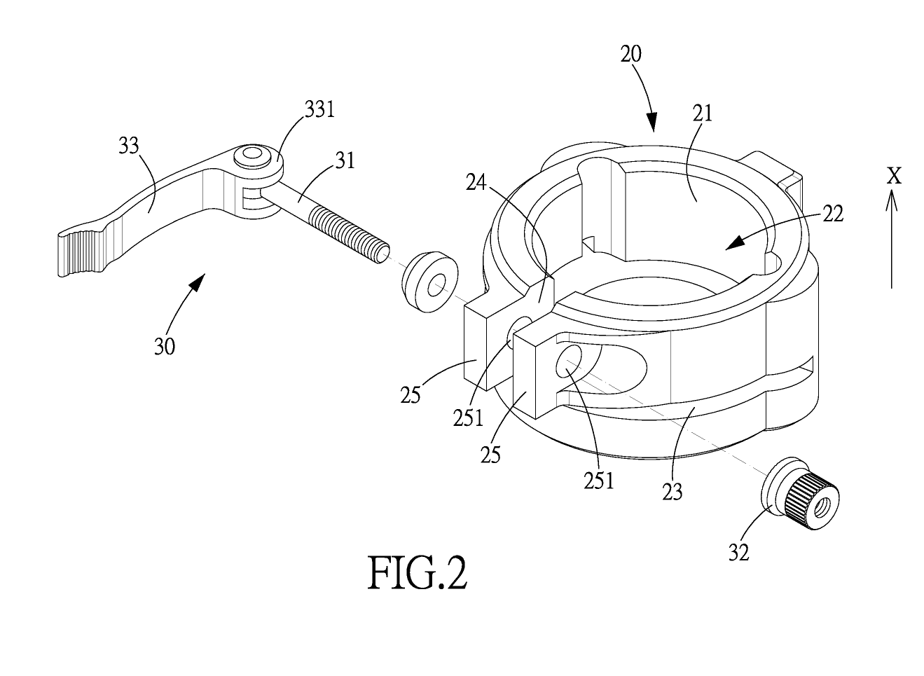

The tensioning device 30, as shown in FIGS. 2-5, is a quick-release device which includes a bolt 31, a nut 32 and a handle 33. The bolt 31 is inserted through the two assembling portions 25 in such a manner that one end of the bolt 31 extends out of the assembling portions 25 and is screwed with a nut 32, and another end of the bolt 31 extends out of the assembling portions 25 and is pivoted to an eccentric cam portion 331 of the handle 33. Pulling the handle 33 rotates the eccentric cam portion 331, which consequently causes the assembling portions 25 to be tightened or loosened.

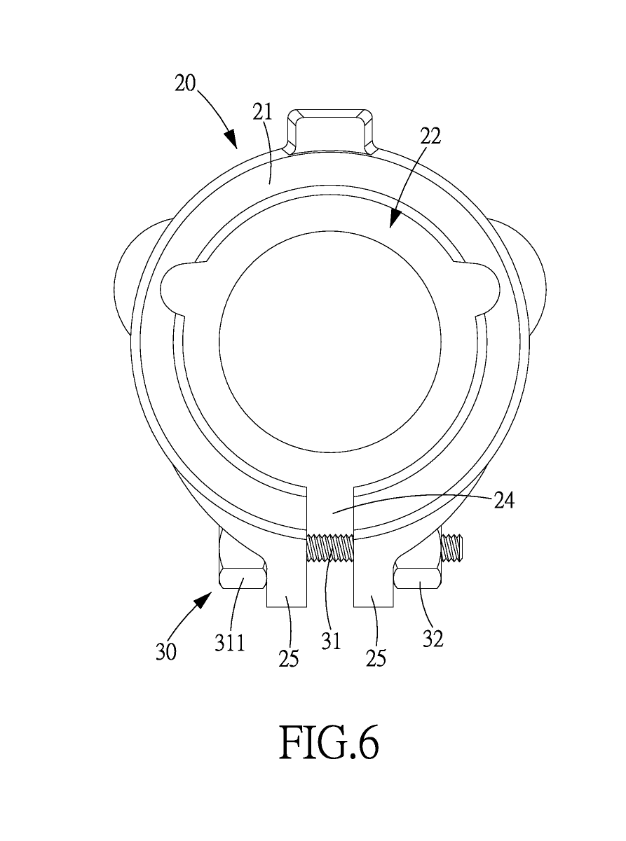

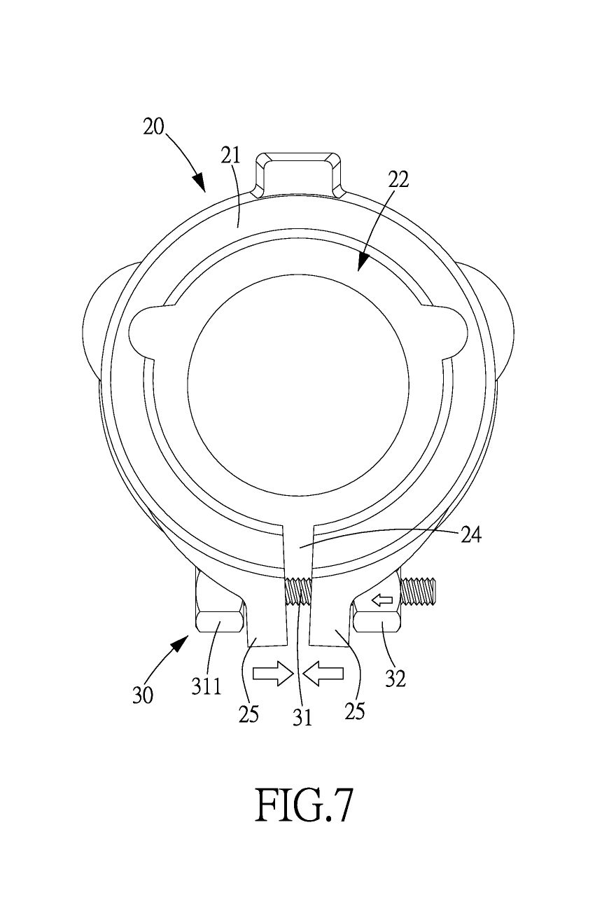

The tensioning device 30 can also be just provided with a bolt 31 and a nut 32, as shown in FIGS. 6 and 7. The bolt 31 is inserted through the two holes 251 and has a head portion 311 stopped against one of the assembling portions 25 and has an end screwed with the nut 32. Rotating the nut 32 can tighten or release the two assembling portions 25.

The tensioning device 30 allows for quick tightening and releasing of the two assembling portions 25. When the tensioning device 30 tightens the two assembling portions 25, the annular slot 23 and the gap 24 allows for micro deformation of the two assembling portions 25, so that, when the two assembling portions 25 slightly deform toward each other by pulling the handle 33 (the two assembling portions 25 are pushed to move toward with each other by pulling the handle 33), the tool inserted in the inserting hole 22 can be clamped tightly. Furthermore, the use of the tool holder of the present invention is not restricted by the configuration of the tool to be held, namely, the tool holder is applicable to all the tools with or without steel ball positioning cavity.

While we have shown and described various embodiments in accordance with the present invention, it is clear to those skilled in the art that further embodiments may be made without departing from the scope of the present invention.

What is claimed is:

1. A tool holder with tensioning design, comprising:
a body being a hollow cylinder with a peripheral wall and a tool inserting hole, around the peripheral wall being formed an annular slot, the peripheral wall being further provided with a gap which extends along an axial direction of the body and in communication with the annular slot, the body being provided with two assembling portions at two sides of the gap; and
a tensioning device disposed at the two assembling portions to tighten or loosen the two assembling portions.

2. The tool holder with tensioning design as claimed in claim 1, wherein the assembling portions take the form of an ear and each are formed with a hole, and the two holes are aligned with each other, the tensioning device is a quick-release device which includes a bolt, a nut and a handle, the bolt is inserted through the two assembling portions in such a manner that one end of the bolt extends out of the assembling portions and is screwed with a nut, and another end of the bolt extends out of the assembling portions and is pivoted to an eccentric cam portion of the handle, pulling the handle causes the assembling portions to be tightened or loosened.

3. The tool holder with tensioning design as claimed in claim 1, wherein the assembling portions each are formed with a hole, and the two holes are aligned with each other, the tensioning device is provided with a bolt and a nut, the bolt is inserted through the two holes and has a head portion stopped against one of the assembling portions and has an end screwed with the nut, rotating the nut tightens or releases the two assembling portions.

4. The tool holder with tensioning design as claimed in claim 1, wherein the annular slot is longer than ½ of a circumference of the peripheral wall.

5. The tool holder with tensioning design as claimed in claim 4, wherein a length of the annular slot is ⅔ of a circumference of the peripheral wall.
